(19) United States
(12) Patent Application Publication
(10) Pub. No.: US 2004/0213576 A1
(43) Pub. Date: Oct. 28, 2004

(54) Optical transceiver for data transfer and control applications

(76) Inventors: Wee Sin Tan, Singapore (SG); Ramana V. Pamidighant, Singapore (SG); Suresh Basoor, Singapore (SG)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/337,757

(22) Filed: Jan. 7, 2003

(30) Foreign Application Priority Data
Mar. 14, 2002 (SG) 200201560-0

(51) Int. Cl. H04B 10/00

(52) U.S. Cl. 398/140

(57) ABSTRACT

An optical transceiver device combines the functions of IrDa-compliant infrared transceivers and remote control devices. A receiver of the transceiver allows the remote control facilities of the transceiver to encompass bidirectional remote control capabilities. The first transmitter and the first receiver can be used for IrDA-compliant infrared communications, and the second transmitter and the first receiver can be used for remote control applications. A first frequency band for IrDA-compliant communications is approximately 805 nm to 900 nm, and a second frequency band for remote control communications is approximately 915 nm to 965 nm. The receiver designed for receiving signals in the first frequency band is not particularly selective and, as a result, is able to detect remote control signals transmitted in the second frequency band.

### FIELD OF THE INVENTION

The present invention relates to optical transceivers used for data transfer and control applications.

### BACKGROUND

An infrared (IR) transceiver module typically comprises an IR light emitting diode (LED) operating at 870 nm and a photodiode, packaged together with appropriate supporting circuitry to form a self-contained unit.

Electrical terminals are exposed on the outside of the self-contained unit to enable electrical coupling to external circuitry. To facilitate use of the unit, the light output from the LED illuminates a large area (typically a cone of +/−15°). Consequently, a user need not precisely align the transmitter and receiver.

By combining various components of an IR transceiver into a single package, the size and form factor of the transceiver can be considerably reduced. Further, the package is typically more durable and may consume less power than equivalent transceivers comprising discrete components. IR transceivers are used extensively in a wide variety of consumer and personal electronic appliances, such as cellular telephones, personal digital assistants and laptop computers. Such appliances typically include an IR transmitting window, which is referred to as a “cosmetic window”.

The Infrared Data Association (IrDA) is an industry organization that promotes international standards for hardware and software used in IR communication links. Most IR communications functionality included in consumer and personal appliances conforms with IRDA specifications. FIG. 1 schematically represents an example of two IRDA-compliant devices communicating via an IR link. Device A 110 communicates with device B 120 via IR link 130.

When an IR link communication channel is created between two IR transceiver modules, the LED in the first transceiver optically couples with the photodiode in the second transceiver. Further, the LED in the second transceiver optically couples with the photodiode in the first transceiver. Although IR transceivers using IR frequency bands are commonly used, other frequency bands can also be used. The IR transceiver module is deeply mounted on an end portion of a main printed circuit board (PCB). This transceiver module comprises a main body having a moulded lens shape over the LED and the photodiode.

### SUMMARY

An optical transceiver device is described herein for combining the functions of IrDa-compliant infrared transceivers and remote control devices. A receiver of the transceiver allows the remote control facilities of the transceiver to encompass bi-directional remote control capabilities.

The described optical transceiver includes a first transmitter, operating around a first frequency band, that transforms electrical signals into transmitted optical signals. A second transmitter, operating around a second frequency band different from said first frequency band, is used to transform electrical signals into transmitted optical signals. A receiver, operating around the first frequency band, is used to transform into electrical signals optical signals received in the first frequency band. The first transmitter and the second transmitter can independently transmit data, and the receiver can receive data from a corresponding transmitter similar to said first transmitter.

The first transmitter can be used for IrDA-compliant infrared communications, and the second transmitter can be used for remote control applications. For instance, the first frequency band may be approximately 805 nm to 900 nm, and the second frequency band is approximately 915 nm to 965 nm. The receiver may not be particularly selective and, as a result, is able to detect remote control signals transmitted in the second frequency band.

The first transmitter and the second transmitter preferably includes respective light emitting diodes, which are both within a transmitter lens to achieve a desired viewing angle. The receiver may then comprise a photodiode. The first transmitter and the second transmitter are usefully formed on a single integrated circuit.

### DESCRIPTION OF DRAWINGS

FIG. 1 is a schematic representation of infrared communication between two devices.

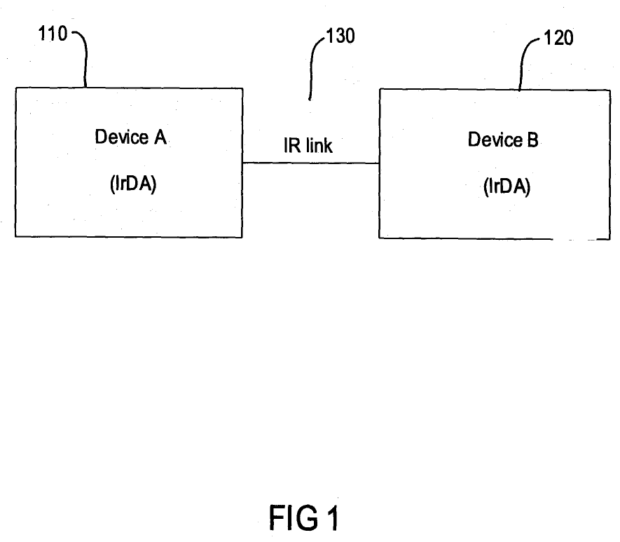

FIG. 2 is a schematic representation of an example of a communication protocol for remote control communication.

FIG. 3 is a schematic representation of a side view of a housing for an optical transceiver described herein.

FIG. 4 is a schematic representation of the housing of FIG. 3, as viewed from above.

FIG. 5 is an electrical circuit schematic representation of circuitry for an optical transceiver described herein, housed in the housing of FIGS. 3 and 4.

FIG. 6 is an electrical circuit schematic representation of switching circuitry external to the configuration represented in FIG. 5.

### DETAILED DESCRIPTION

An optical transceiver that combines functionality for IrDA-compliant infrared communications and remote control infrared communications is described herein. An overview of remote control communications is provided, followed by a comparison of infrared and remote control communications. The hybrid optical transceiver that combines these respective facilities is then described in detail, together with possible applications for this hybrid transceiver.

Remote Control Transmitter

A remote control transmitter comprises an IR LED (operating at 940 nm), which is electrically connected to a switching transistor and a battery supply. When a key is pressed on a handheld remote control unit, a predetermined pulse pattern is generated. This pulse pattern is activated by a transistor, and the LED is consequently activated. An IR signal from the LED is received by a remote control receiver (in, for example, an appliance), and the encoded function communicated by the pulsed pattern is decoded.

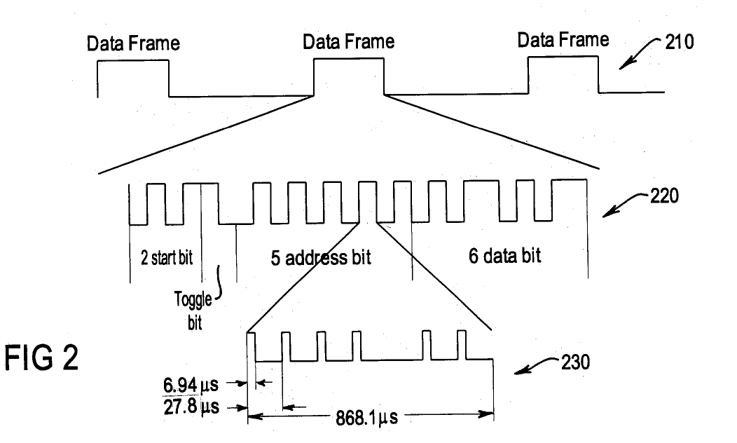

Communication using remote control devices is uni-directional. There is no common standard for remote control coding. RC5 code is one remote control code. FIG. 2 schematically represents a modulation scheme used by RC5 codes. A remote control signal generated using RC5 comprises a series of data frames 210. Each data frame 210 comprises a command word 220 consisting of 14 bits. The structure of this command word 220 is indicated in FIG. 2. Each bit 230 comprises 32 pulses at a frequency of 36 kHz.

Many remote receivers have a relatively narrow spectral reception band centred around 940 nm. Such receivers are not able to receive IR emission from IrDA-compliant transceivers operating at 870 nm reliably.

Comparison of Remote Control and IrDa Specifications

Table 1 below tabulates, in comparative form, the difference between various parameters of typical remote control systems, and IrDA-compliant systems.

TABLE 1

| | Remote Control | IrDA |
|---|---|---|
| Wavelength (nm) | 915-965 | 805-900 |
| Transmission | Unidirectional | Bi-directional |
| Frame format | Proprietory for each | Defined by IrDA |
| | vendor | |
| Modulation | Bi-Phase, Pulse length, | RZI, 3-16 duration |
| | and Pulse Distance | |
| Receiver sensitivity | 0.05 μW/cm² | 4 μW/cm² |
| Link Distance | 8 m (typical) | 1 m |
| Transmit Angle | +/−20° | +/−15° |
| Carrier Frequency | 30-60 khz | |
| Receiver bandwidth | Carrier Freq +/− 2 kHz | Wide bandwidth |
| Data Rate | 2000-4000 bps | 2.4 bps-16 Mbps |

These two IR schemes are relatively similar, though these schemes are not compatible with each other and consequently cannot inter-operate.

Hybrid Transceiver

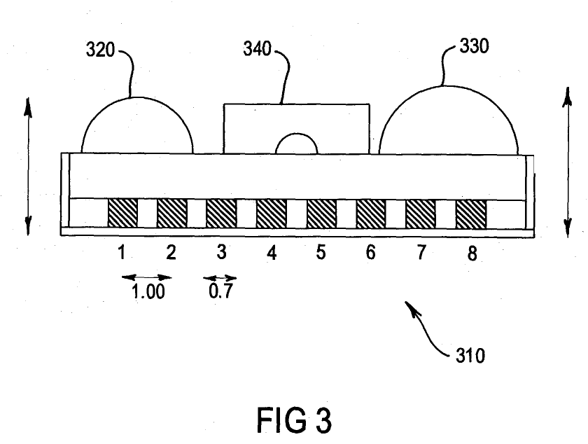

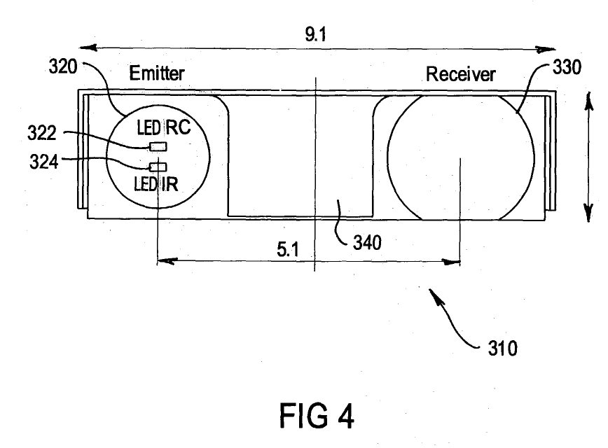

FIG. 3 schematically represents a side view of an IR transceiver package 310, in which the described hybrid transceiver can be housed. FIG. 4 schematically represents the same package from above. With reference to FIGS. 3 and 4, emitter 320 and receiver 330 are provided at either end of the package 310, with a shield 340 separating the emitter lens 320 and the receiver lens 330. The emitter 320 houses not only an IR LED (840 nm) 324 but also a remote control LED (940 nm) 322. The profile of the emitter lens 320 is not modified to accommodate the remote control LED.

The two LEDs 322, 324 are accurately positioned with respect to the optical axis of the emitter lens 320, to achieve a suitable viewing angle at a receiver.

The electrical circuit supporting the two transmitters is configured so that the operating current through each LED 322, 324 is appropriate. This configuration assists in producing a relatively low-power IRDA transceiver and a standard remote control transmitter. Each package of the designed component also includes sufficient heat sink material around the two LEDs 322, 324 to achieve sufficient thermal dissipation.

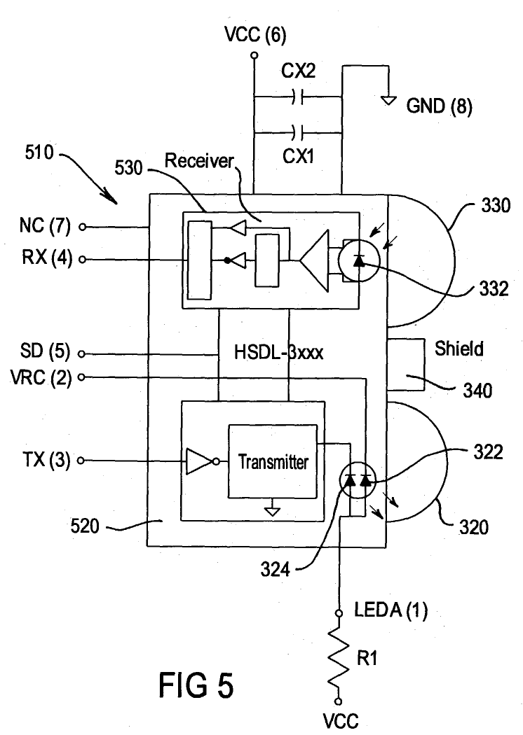

FIG. 5 schematically represents electrical circuitry 510 supporting the two transmitters incorporated in the package 310 of FIGS. 3 and 4. This circuitry 510 is based upon a HSDL 3000 Stargate platform, which is selected for a lower idle current specification, and as this component is qualified at a relatively high operating current. The transceiver circuitry 510 comprises transmitter circuitry 520 and receiver circuitry 530, which respectively support the operation of the two transmitter LEDs 322, 324 and the receiver photodiode 332.

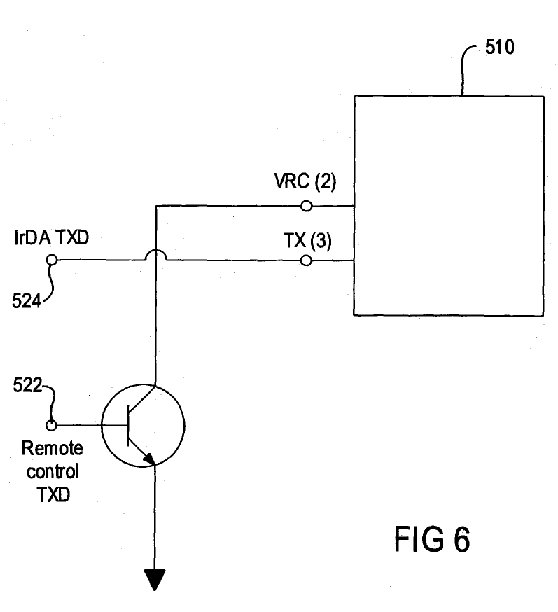

FIG. 6 schematically represents switching circuitry external to the transceiver circuitry 510 of FIG. 5. Independent inputs 522, 524 are provided for respective transmitting LEDs 322, 324. The advantages of this represented configuration are that (i) data can be transmitted using one or both LEDs 322, 324, and (ii) operating currents can be independently configured for each LED 322, 324.

### APPLICATIONS

The described hybrid transceiver is suited to remote control transmission in a bi-directional mode. For example, a user can activate an appliance from an held-hand remote control, and the appliance transmits back to the held hand remote control a menu of possible selections to the user. Examples of such selections include temperature and humidity settings from an air conditioner, a song list from a compact disc player, lighting controls from a multimedia device. The user can select an desired choice from the menu, and then transmits this selection to the appliance.

In this case, the receiver circuitry of the IRDA receiver is used to receive and interpret data from the remotely controlled appliance. The IrDA receiver is not particularly selective, and can interpret remote control frequency signals centred around 940 nm.

A particular advantage of using an IrDA transceiver for bi-directional remote control is that the transceiver receiver circuitry follows a similar logic to that required for bi-directional remote control functionality. The presence of light provides a “low” signal output and the absence of light provides a “high” signal output. Thus, the IR transmitter can provide a digitized output by receiving a remote control bit pattern, which obviates the need for an external digitizer. The IrDA transceiver also incorporates ambient light filtering, which is also suitable for receiving a remote control data signal.

Various exemplary relative measurements and circuitry are shown in the representations. These are exemplary and not limiting on the broadest aspect of the invention.

Various alterations and modifications can be made to the arrangements and techniques described herein, as would be apparent to one skilled in the relevant art.

1. An optical transceiver device comprising:
a first transmitter, operating around a first frequency band, that transforms electrical signals into transmitted optical signals;
a second transmitter, operating around a second frequency band different from said first frequency band, that transforms electrical signals into transmitted optical signals; and
a receiver, operating around the first frequency band, that transforms into electrical signals optical signals received in the first frequency band;
wherein the first transmitter and the second transmitter can independently transmit data, and the receiver can receive data from a corresponding transmitter similar to said first transmitter.

2. The transceiver device as claimed in claim 1, wherein the first transmitter and the second transmitter comprise respective light emitting diodes.

3. The transceiver device as claimed in claim 1, wherein the first transmitter and second transmitter are housed within a same transmitter lens to achieve a desired viewing angle.

4. The transceiver device as claimed in claim 1, wherein the first transmitter and the second transmitter are formed on a single integrated circuit.

5. The transceiver device as claimed in claim 1, further comprising transmitter circuitry for supplying a modulated electrical signal to the first transmitter.

6. The transceiver device as claimed in claim 1, wherein the receiver comprises a photo diode.

7. The transceiver device as claimed in claim 1, wherein one of the first and second frequency bands is approximately 805 nm to 900 nm, and the other of the first and second frequency bands is approximately 915 nm to 965 nm.

8. The transceiver device as claimed in claim 1, wherein the first transmitter can be used for IrDA-compliant infrared communications, and the second transmitter can be used for remote control applications.

9. The transceiver device as claimed in claim 1, further comprising a shield between said first and second transmitters and said first receiver.

10. The transceiver device as claimed in claim 1, wherein the first and second transmitters and the receiver all reside within a unitary package.

11. The transceiver device as claimed in claim 1, wherein the receiver is further operable to receive optical signals in the second frequency band and transform them into electrical signals.

12. An optical transception method, comprising:
transforming electrical signals into transmitted optical signals using a first transmitter operating in a first frequency band;
transforming electrical signals into transmitted optical signals using a second transmitter operating in a second frequency band; and
transforming optical signals into electrical signals using a first receiver able to accept signals transmitted in the first frequency band;
wherein the first transmitter and second transmitter can independently transmit data, and the receiver can receive data from a corresponding transmitter similar to said first transmitter.

13. The method as claimed in claim 12, wherein the first transmitter and the second transmitter comprise respective light emitting diodes.

14. The method as claimed in claim 12, wherein the first transmitter and second transmitter are housed within a same transmitter lens to achieve a desired viewing angle.

15. The method as claimed in claim 12, wherein the first transmitter and the second transmitter are formed on a single integrated circuit.

16. The method as claimed in claim 12, further comprising the step of supplying a modulated electrical signal to the first transmitter.

17. The method as claimed in claim 12, wherein one of the first and second frequency bands is approximately 805 nm to 900 nm, and the other of the first and second frequency bands is approximately 915 nm to 965 nm.
